(19) United States
(12) Patent Application Publication
(10) Pub. No.: US 2026/0005579 A1
(43) Pub. Date: Jan. 1, 2026

(54) ROTARY POWER TOOL

(71) Applicant: MILWAUKEE ELECTRIC TOOL CORPORATION, Brookfield, WI (US)

(72) Inventors: Justin T. Bickman, Milwaukee, WI (US); Travis J. Dubnicka, Menomonee Falls, WI (US); Alex D. Servais, Slinger, WI (US); Timothy N. Hunt, Waukesha, WI (US)

(21) Appl. No.: 19/207,516

(22) Filed: May 14, 2025

Related U.S. Application Data
(60) Provisional application No. 63/647,303, filed on May 14, 2024.
(60) Provisional application No. 63/664,894, filed on Jun. 27, 2024.

(51) Int. Cl. H02K 7/14; F21L 4/02; F21V 15/04; F21V 31/04; F21V 33/00; F21W 111/10; F21Y 115/10; H02K 5/24; H02K 11/00; H02K 11/33

(52) U.S. Cl. CPC H02K 7/145; F21L 4/02; F21V 15/04; F21V 31/04; F21V 33/0084; H02K 5/24; H02K 11/0094; H02K 11/33; F21V 2200/00; F21W 2111/10; F21Y 2115/10; H02K 2211/03

(57) ABSTRACT

A power tool includes a housing, an electric motor disposed within the housing, a first printed circuit board assembly configured to selectively supply electric current to the electric motor, causing the electric motor to activate and drive a tool element, and a battery receptacle configured to support a removable battery pack. The battery receptacle has a battery terminal block electrically connected to the battery pack to supply electrical current to the first printed circuit board assembly. The power tool further includes a second printed circuit board assembly electrically connected between the first printed circuit board assembly and the battery terminal block. The second printed circuit board assembly has a fuse and a thermistor configured to detect a temperature of the fuse.

### CROSS-REFERENCE TO RELATED APPLICATIONS

This application claims priority to U.S. Provisional Patent Application No. 63/664,894, filed Jun. 27, 2024, and U.S. Provisional Patent Application No. 63/647,303, filed May 14, 2024, the entire contents of both of which are incorporated herein by reference.

### FIELD OF THE INVENTION

The present invention relates to rotary power tools, and in particular to die grinders.

### BACKGROUND OF THE INVENTION

Many of the portable grinding tools currently available that run at high operating speeds (e.g., 20,000 revolutions per minute (rpm) or greater) are pneumatic tools. Pneumatic motors powering these tools typically have very short output shafts that do not produce significant vibration at such high operating speeds (e.g., from 20,000 to 24,000 rpm). Electric motors, however, typically have longer rotor (or output) shafts, which tend to be more flexible and experience resonant vibration that shake the tool.

### SUMMARY OF THE INVENTION

The invention provides, in one aspect, a power tool including a housing, an electric motor disposed within the housing, a first printed circuit board assembly configured to selectively supply electric current to the electric motor, causing the electric motor to activate and drive a tool element, and a battery receptacle configured to support a removable battery pack. The battery receptacle has a battery terminal block electrically connected to the battery pack to supply electrical current to the first printed circuit board assembly. The power tool also includes a second printed circuit board assembly electrically connected between the first printed circuit board assembly and the battery terminal block. The second printed circuit board assembly has a fuse and a thermistor configured to detect a temperature of the fuse.

The invention provides, in another aspect, a power tool including a tool housing, an electric motor disposed within the tool housing, a first printed circuit board assembly configured to selectively supply electric current to the electric motor, causing the electric motor to activate and drive a tool element, and a battery receptacle configured to support a removable battery pack. The battery receptacle having a battery terminal block electrically connected to the battery pack to supply electrical current to the first printed circuit board assembly. The tool also includes a light assembly supported within the tool housing and configured to indicate a state of charge of the battery pack. The light assembly includes an auxiliary housing and an auxiliary printed circuit board supported within the housing. The auxiliary printed circuit board having a plurality of light-emitting diodes (LEDs) mounted thereto. The light assembly also includes a plurality of light pipes extending through the tool housing and having respective distal ends that are visible from an exterior of the tool housing. The light pipes are positioned adjacent the respective LEDs to transmit light emitted from the LEDs to the exterior of the tool housing.

The invention provides, in another aspect, a light emitting diode fuel gauge assembly configured to display a state of charge of a battery pack. The light emitting diode fuel gauge assembly includes an auxiliary housing, and an auxiliary printed circuit board supported within the auxiliary housing. The auxiliary printed circuit board having a plurality of light-emitting diodes (LEDs) mounted thereto. The assembly also includes a plurality of light pipes configured to extend through a tool housing and having respective distal ends that are configured to be visible from an exterior of the tool housing. The light pipes are positioned adjacent the respective LEDs and are configured to transmit light emitted from the LEDs to the exterior of the tool housing.

Other aspects of the invention will become apparent by consideration of the detailed description and accompanying drawings.

### BRIEF DESCRIPTION OF THE DRAWINGS

FIG. 1 is a front perspective view of a rotary power tool, such as a die grinder.

FIG. 2 is a rear perspective view of the die grinder of FIG. 1.

FIG. 3 is a cross-sectional view of the die grinder of FIG. 1.

FIG. 4 is a side cross-sectional view of a portion of the portable rotary power tool of FIG. 1, illustrating an air flow path through the motor.

FIG. 5 is an exploded view of the portable rotary power tool of FIG. 1.

FIG. 6 is a rear perspective view of a bezel of the die grinder of FIG. 1, illustrating a lighting assembly and a spindle lock assembly.

FIG. 7 is a rear view of the bezel and lighting assembly of FIG. 6.

FIG. 8 is a front perspective view of the bezel and lighting assembly of FIG. 6.

FIG. 9 is a cutaway view of a portion of the die grinder of FIG. 1, illustrating an auxiliary printed control board assembly and a battery terminal block.

FIG. 10 is a perspective view of the auxiliary printed control board assembly of FIG. 9, illustrating a thermistor.

FIG. 11 is a rear view of the die grinder of FIG. 1, illustrating a user interface having a first and second light assembly.

FIG. 12 is a perspective view of an exemplary light assembly electrically connected to a printed circuit board assembly according to another embodiment of the disclosure.

FIG. 13 is a perspective view of the light assembly of FIG. 12.

FIG. 14 is a perspective view of an auxiliary housing and light pipes of the light assembly of FIG. 12.

FIG. 15 is a side cross-sectional view of the light assembly of FIG. 12 supported within a tool housing of the die grinder of FIG. 1.

FIG. 16 is a perspective view of a printed circuit board of the light assembly of FIG. 12, illustrating a plurality of LEDs mounted to the circuit board.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

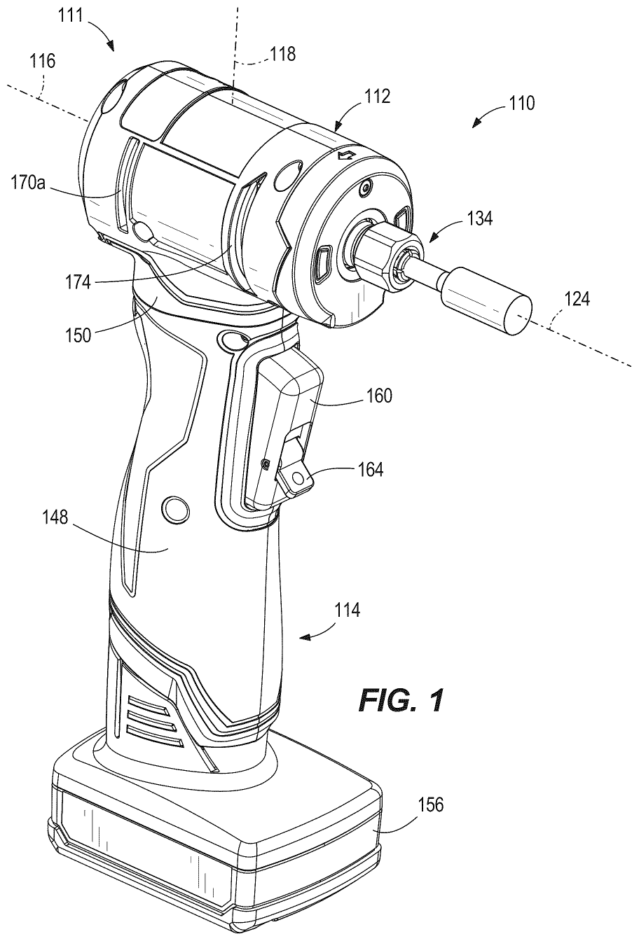

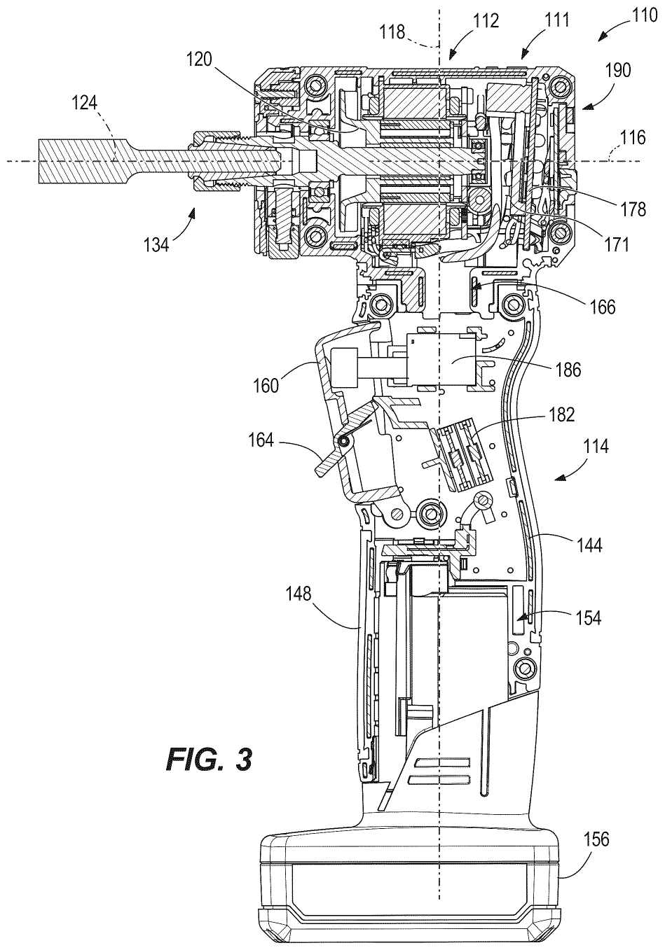

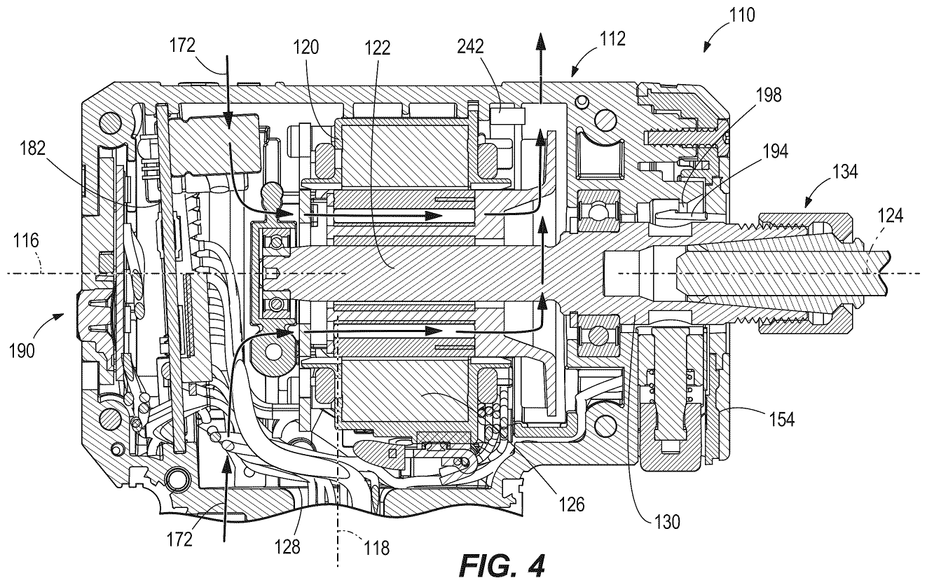

FIGS. 1-5 illustrate a portable powered grinding tool, such as a die grinder 110, according to an embodiment of the invention. The die grinder 110 includes a tool housing 111 having a motor housing 112 and a handle 114 extending transversely from the motor housing 112. The motor housing 112 extends along a first axis 116, and the handle 114 extends along a second axis 118 (FIG. 3) which is transverse to the first axis 116. An electric motor 120 (FIGS. 3 and 4) is located within the motor housing 112. The electric motor 120 includes a rotor shaft 122 (FIG. 4) extending longitudinally therethrough and defining a motor axis 124. In the illustrated embodiment, the first axis 116 is coaxial with the motor axis 124.

With reference to FIG. 4, the electric motor 120 also includes a rotor 126 and a stator 128 that surrounds the rotor 126. The stator 128 is supported within the motor housing 112 and remains stationary relative to the motor housing 112 during operation of the die grinder 110. The rotor 126 is rotatably fixed to the rotor shaft 122 and configured to co-rotate with the rotor shaft 122, relative to the stator 128, about the motor axis 124. A portion of the rotor shaft 122 defines an output shaft 130 extending from the motor housing 112. A distal end of the output shaft 130 is coupled to a tool holder 134 configured to receive a tool element (e.g., a grinding disc, a rotary burr, etc.).

With reference to FIG. 5, the motor housing 112 includes a pair of motor half housings 140 coupled together via fasteners. The handle 114 likewise includes a pair of handle half housings 144 coupled together via fasteners. A grip 148 is overmolded on the handle 114 and divided into a pair of grip portions 148 adhered to each respective handle half housing 144. Similarly, a cover 150 is overmolded on the motor housing 112 and divided into a pair of cover portions adhered to each respective motor half housing 140. A bezel 152 is snap fit to the motor housing 112 proximate the tool holder 134. The motor half housings 140 and the handle half housings 144 are formed of a relatively hard plastic material (e.g., ABS, PA, PP, PC, etc.), whereas the overmolded grip 148 and cover 150 are each formed from a relatively softer material (e.g., a thermoplastic elastomer, rubber, etc.).

With reference to FIG. 3, the handle 114 defines a battery receptacle 154, which is positioned on an end of the handle 114 opposite the motor housing 112. The battery receptacle 154 is configured to selectively mechanically and electrically connect to a removable battery pack 156 for powering the electric motor 120. The battery pack 156 is insertable into the battery receptacle 154 such that, when inserted, the battery pack 156 may be oriented along the second axis 118. Alternatively, in another embodiment of the die grinder 110, the battery pack 156 may be slidably coupled to the battery receptacle 154 along an axis that is transverse to the second axis 118. The battery pack 156 may include any of a number of different nominal voltages (e.g., 12V, 18V, etc.), and may be configured having any of a number of different chemistries (e.g., lithium-ion, nickel-cadmium, etc.). In alternative embodiments (not shown), the electric motor 120 may be powered by a remote power source (e.g., a household electrical outlet) through a power cord. The handle 114 further contains control electronics for the die grinder 110, which are discussed later in detail below.

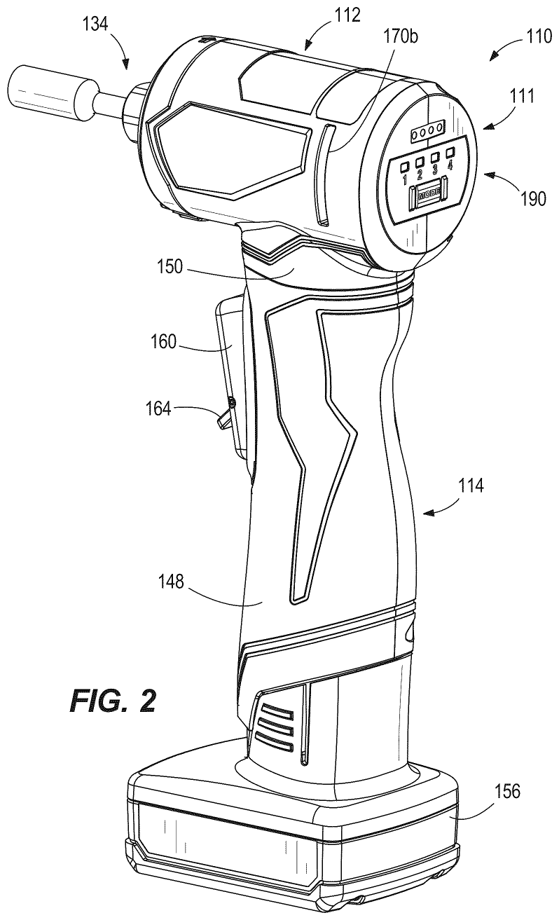

The handle 114 supports a trigger 160 which, in turn, supports a lock-off mechanism 164. The trigger 160 is operable to selectively electrically connect the power source (e.g., the battery pack 156) and the electric motor 120. The lock-off mechanism 164 (FIGS. 1 and 2) inhibits inadvertent actuation of the trigger 160. The die grinder 110 further includes a vibration damping assembly 166 (FIG. 3) positioned between the motor housing 112 and the handle 114 to attenuate vibration from the motor housing 112. In some constructions, the vibration damping assembly 166 can take the form of the vibration damping assembly 166 disclosed in U.S. patent application Ser. No. 17/051,921 filed Oct. 30, 2020, the entire content of which is incorporated herein by reference.

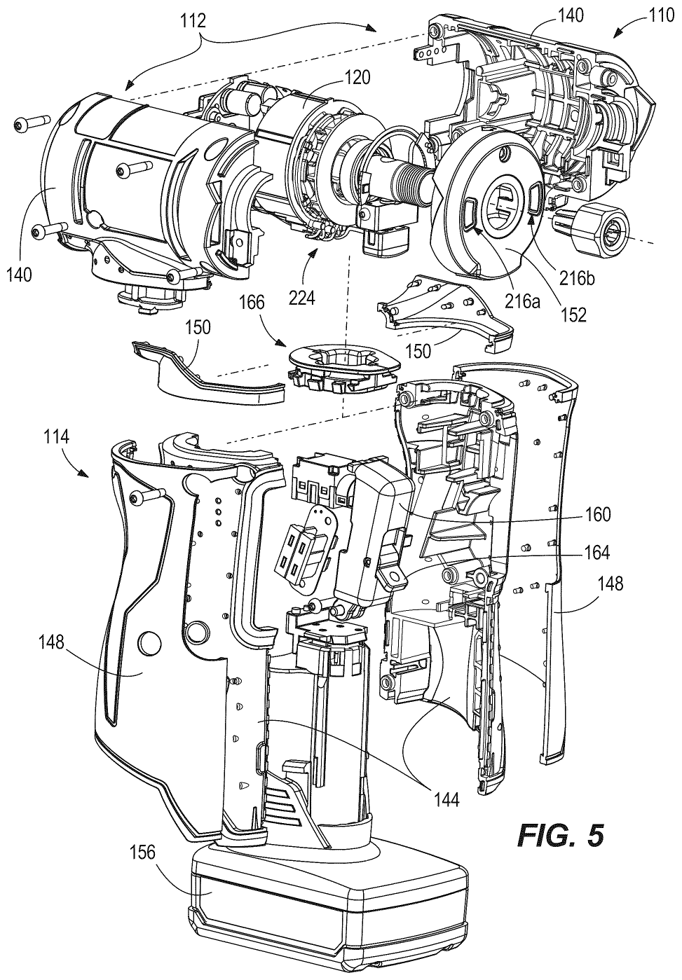

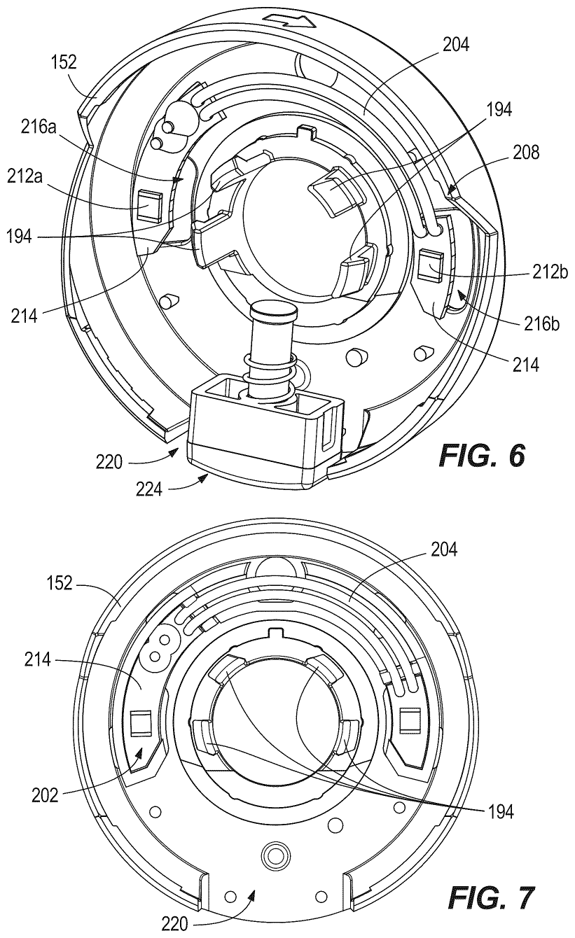

Now with reference to FIGS. 1, 2, and 4, the motor housing 112 includes a pair of air inlets 170a (FIG. 1), 170b (FIG. 2) and an air outlet 174 defined therein. The die grinder 110 further includes a fan 171 operably coupled to the motor 120. The air inlets 170a, 170b are formed on each side of the electric motor 120 such that an air flow 172 (FIG. 6) enters the motor housing 112 on each side of the electric motor 120. The air outlet 174 is formed on the same side of the motor housing 112 as the air inlet 170a. During operation, the fan 171 is driven by the electric motor 120, which induces the air flow 172 to enter the motor housing 112. The air flow 172 enters the motor housing 112 through the air inlets 170a, 170b at a position behind the electric motor 120, passes over the electric motor 120 and exits the motor housing 112 on a single side of the motor housing 112. The construction of the air outlet 174 ensures that the air flow 172 travels over the entire motor 120. In the illustrated embodiment, the air inlets 170a, 170b have a cross-sectional area of 180 mm² and the air outlet 174 has a cross-sectional area of 210 mm². In other embodiments, the air inlets 170a, 170b may have a cross-sectional area in a range of 100 mm² to 300 mm² and the air outlet 174 may have a cross-sectional area in a range of 200 mm² to 300 mm².

Now with reference to FIG. 3, the die grinder 110 includes a first printed circuit board assembly (PCBA) 178 positioned within the motor housing 112 and electronically connected to the motor 120 and a second printed control board assembly (PCBA) 182 is electrically connected to the first PCBA 178. The die grinder 110 further includes a variable speed trigger switch 186 in electrical communication with the first PCBA 178 and is operably coupled to the trigger 160. The first PCBA 178 is configured to control power to the motor 120 and receive signals from the second PCBA 182 and the variable speed trigger switch 186 to selectively activate the motor 120 in response to actuation of the trigger 160.

With reference to FIG. 2, the die grinder 110 further includes a user interface 190 (e.g., membrane switch, etc.) disposed on a rear end of the motor housing 112 opposite the tool holder 134. Specifically, the user interface 190 is disposed at least partially on the exterior of the motor housing 112 and is situated adjacent and parallel to the first PCBA 178 (FIG. 3). The user interface 190 has various mode selections, which can control the electric motor 120 based on user input. In the illustrated embodiment, the user interface 190 allows the user to adjust the mode of the die grinder 110 between four maximum speed modes (e.g., RPM) for the electric motor 120. In other embodiments, the user interface 190 may allow the user to adjust between more or fewer modes. The user interface 190 is electrically connected to the first PCBA 178 and is configured to provide a signal to the first PCBA 178 to selectively adjust the operating modes of the die grinder 110.

Now with reference to FIGS. 4 and 6-8, the bezel 152 includes a plurality of latches 194 that engage a protrusion 198 (FIG. 4) formed on the motor housing 112 in a snap-fit arrangement. The bezel 152 further includes a recess 202 (FIG. 7) formed on an inner surface, which receives power wires 204 of a lighting assembly 208. For example, the recess 202 may form a wire guide. The lighting assembly 208 is coupled to the bezel 152 and is configured to illuminate a workpiece. The lighting assembly 208 includes a pair of LED lights 212a, 212b coupled to an LED printed control board assembly (PCBA) 214. In some embodiments, the LED PCBA 214 may be a single assembly having both LED lights 212a, 212b or separate LED PCBAs 214 that are electrically connected to each other by the wires 204. The LED PCBA 214 are received within the recess 202 while the pair of LED lights 212a, 212b are received in respective apertures 216a, 216b of the bezel 152. The pair of LED lights 212a, 212b are positioned opposite sides of the tool holder 134 to illuminate each side of the tool holder 134. The lighting assembly 208 may be activated, for example, when the trigger 160 is depressed. The bezel 152 further includes a receiving aperture 220 configured to receive a spindle lock assembly 224 configured to selectively engage with the output shaft 130. Actuating the spindle lock assembly 224 restricts rotation of the output shaft 130, which allows a user to remove the tool element from the tool holder 134.

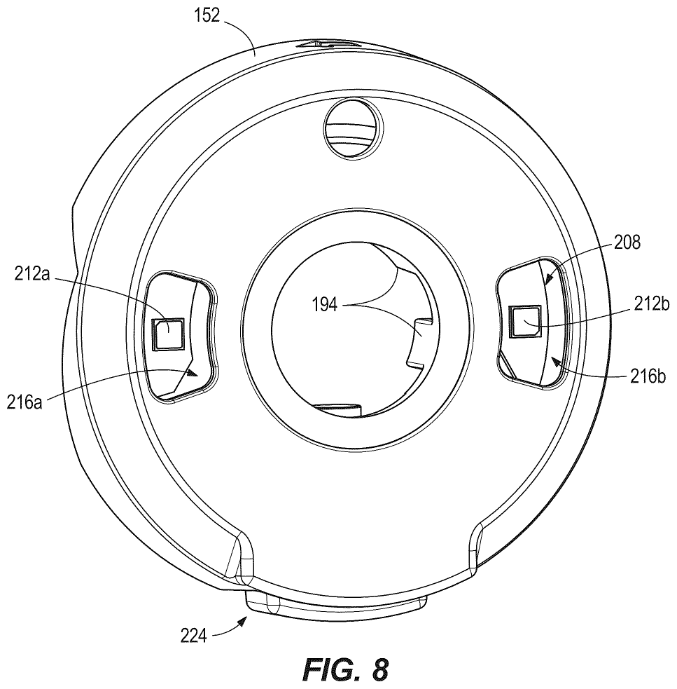

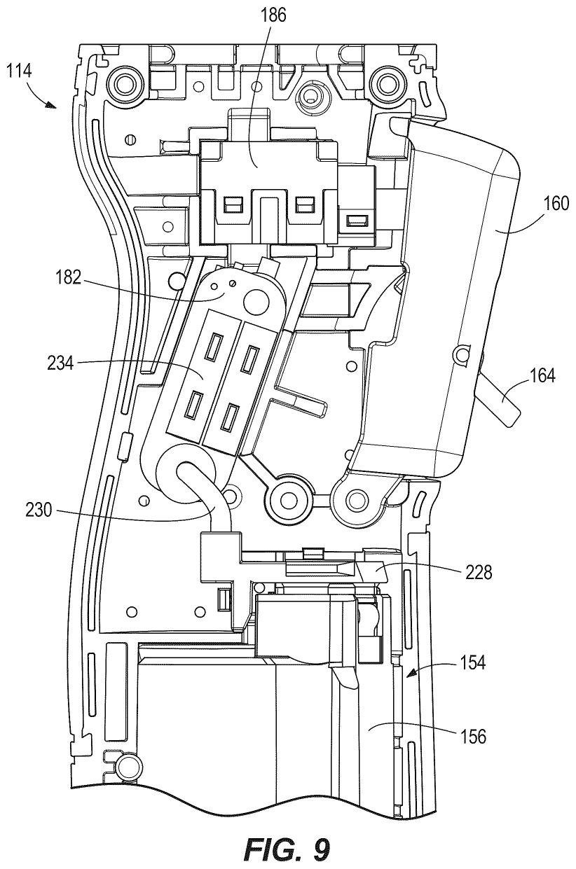

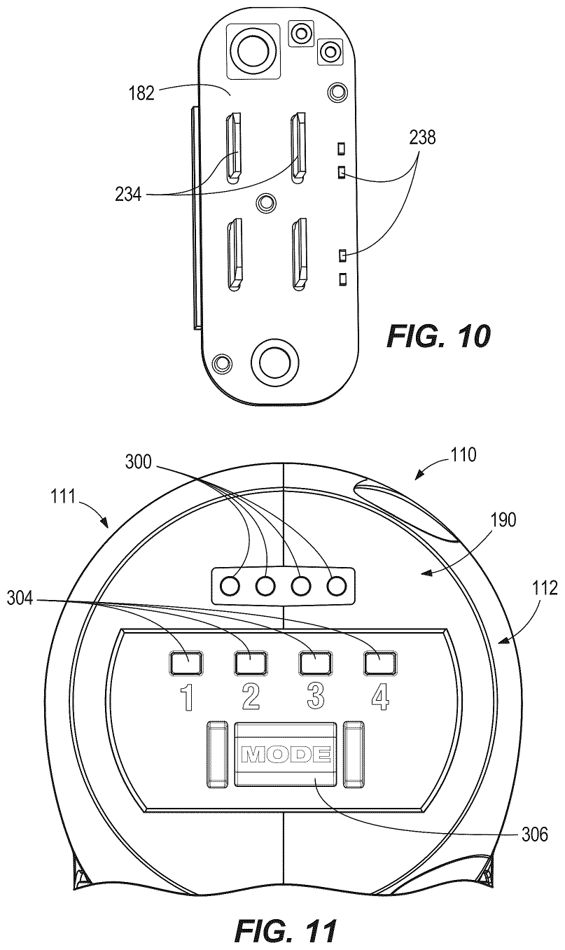

With reference to FIGS. 9 and 10, the battery receptacle 154 supports the removable battery pack 156. The battery receptacle 154 includes a battery terminal block 228 electrically connected to the battery pack 156 to supply electrical current to the first PCBA 178 when the battery pack 156 is inserted within the battery receptacle 154. An electrical wire 230 extends between the second PCBA 182 and the battery terminal block 228 through which electrical current from the battery pack 156 is transmitted to the first PCBA 178. Heat from the battery terminal block 228 is transferred to the second PCBA 182 via the electrical wire 230. In the illustrated embodiment, the second PCBA 182 is positioned in a series circuit between the battery terminal block 228 and the first PCBA 178. In other words, the second PCBA 182 is inline between the battery terminal block 228 and the first PCBA 178.

The second PCBA 182 includes one or more fuses 234 (FIG. 9) and a thermistor 238 (FIG. 10). In the illustrated embodiment, the second PCBA 182 includes two fuses 234 that arranged in parallel with each other. In other embodiments, the second PCBA 182 may include more fuses (e.g., three, four, etc.) or a single fuse. The fuse(s) 234 are positioned inline between the first PCBA 178 and the battery terminal block 228. The second PCBA 182 is positioned proximate the battery terminal block 228 so the thermistor 238 can detect the temperature of the fuse(s) 234, which can indicate excessive electrical current drawn through the fuse(s) 234 to thereby provide overcurrent protection. The second PCBA 182 is in communication with the first PCBA 178 and is configured to provide a signal to the first PCBA 178 corresponding to the temperature of the battery terminal block 228.

For example, the first PCBA 178 may include, among other things, a processing unit (e.g., a microprocessor, a microcontroller, or another suitable programmable device) and a memory. The memory is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The memory is capable of storing an array of data described in detail below. The processing unit is connected to the memory and executes software instructions that are capable of being stored in a RAM of the memory (e.g., during execution), a ROM of the memory (e.g., on a generally permanent basis), or another non- transitory computer readable medium such as another memory or a disc. Software included in the implementation of the die grinder 110 can be stored in the memory of the first PCBA 178. The software includes, for example, an interrupt service routine (ISR), firmware, one or more applications, program data, filters, rules, one or more program modules, and other executable instructions. The first PCBA 178 is configured to retrieve from the memory and execute, among other things, instructions related to the control processes and methods described herein. In other constructions, the first PCBA 178 includes additional, fewer, or different components.

In operation of the die grinder 110, an operator depresses the trigger 160 after moving the lock-off mechanism 164 to activate the electric motor 120, which continuously drives the work tool coupled to the tool holder 134. For example, depressing the trigger 160 actuates the variable speed trigger switch 186, which provides a signal to the first PCBA 178 to activate the electric motor 120. Simultaneously to depressing the trigger 160, the first PCBA 178 activates the lighting assembly 208 to illuminate a workpiece.

When the die grinder 110 is operated for extended period of time (e.g., during grinding, polishing, or the like), the temperature of the electric motor 120, the first PCBA 178, the second PCBA 182, and the battery terminal block 228 may increase due to the current provided to the motor 120 from the battery pack 156. In order to prevent overheating and failure of the first PCBA 178, the electric motor 120, and/or the battery terminal block 228 of the die grinder 110, the second PCBA 182 is positioned in a series circuit between the battery terminal block 228 and the first PCBA 178. The thermistor 238 on the second PCBA 182 is configured to monitor the temperature of the fuse(s) 234. Further, the fuse(s) 234 of the second PCBA 182 protects the first PCBA 178 and the electric motor 120 from excessive current and to prevent short circuits or mismatched loads, which could damage the electric motor 120 and/or the first PCBA 178. In other embodiments, the thermistor 238 may monitor the temperature of the fuse(s) 234 and the temperature of the second PCBA 182.

For example, in response to a detected temperature of the fuse(s) 234 exceeding a predetermined high threshold value due to a spike of electrical current during operation, the first PCBA 178 discontinues or reduces electrical current supplied to the electric motor 120. In some embodiments, correlation between the temperature of the fuse(s) 234 and the temperature of the battery terminal block 228 may be produced to use the fuse(s) 234 for overcurrent protection. In some embodiments, the first PCBA 178 may restrict electrical current supplied to the electric motor 120 until the thermistor 238 of the second PCBA 182 detects that the temperature of the fuse(s) 234 are below a predetermined low threshold value. Once the temperature of the fuse(s) 234 reaches the predetermined low threshold value, the first PCBA 178 allows electrical current to be supplied to the electric motor 120 so the user can operate the die grinder 110. In some embodiments, the die grinder 110 may include a motor thermistor 242 (schematically shown in FIG. 4) positioned proximate the electric motor 120 to detect the temperature of electric motor 120. In some embodiments, the motor thermistor 242 may be positioned on the first PCBA 178 or on an additional, third PCBA. The first PCBA 178 discontinue or reduce electrical current supplied to the electric motor 120 when the temperature of the electric motor 120 exceeds a predetermined high threshold value. In some embodiments, the first PCBA 178 may restrict electrical current suppled to the electric motor 120 until the motor thermistor 242 detects that the temperature of the electric motor 120 is below a predetermined low threshold value. Once the temperature of the electric motor 120 reaches the predetermined low threshold value, the first PCBA 178 allows electrical current to be supplied to the electric motor 120 so the user can operate the die grinder 110. In some embodiments, the first PCBA 178 discontinues or reduce electrical current supplied to the electric motor 120 in response to a detected temperature of the second PCBA 182 exceeding a predetermined high threshold value.

Typically, the electric motor 120 will reach an excess temperature prior to the fuse(s) 234 blowing. However, over the lifetime of the die grinder 110, the fuse(s) 234 may blow due to extended operation or a spike of electrical current beyond a predetermined threshold value. Therefore, the fuse(s) 234 protect the first PCBA 178 and electric motor 120 from failure due to potential spikes of electrical current during operation. If the fuse(s) 234 trip or blow during operation of the die grinder 110, the circuit between the battery pack 156 and the first PCBA 178 is broken, which disables the die grinder 110. Once the die grinder 110 is disabled, the die grinder 110 may be serviced. In some embodiments, the fuse(s) 234 or the entire second PCBA 182 may be replaced. In other embodiments, the first PCBA 178 and/or the electric motor 120 may also be replaced.

Now with reference to FIG. 11, the user interface 190 is illustrated in more detail. The user interface 190 includes a first LED light assembly 300, a second LED light assembly 304, and a mode selector button 306. In the illustrated embodiment, the first LED light assembly 300 is an LED fuel gauge assembly that displays the state of charge of the battery pack 156 (FIG. 3). The second LED light assembly 304 forms an LED mode selection assembly that displays the operating mode of the die grinder 110.

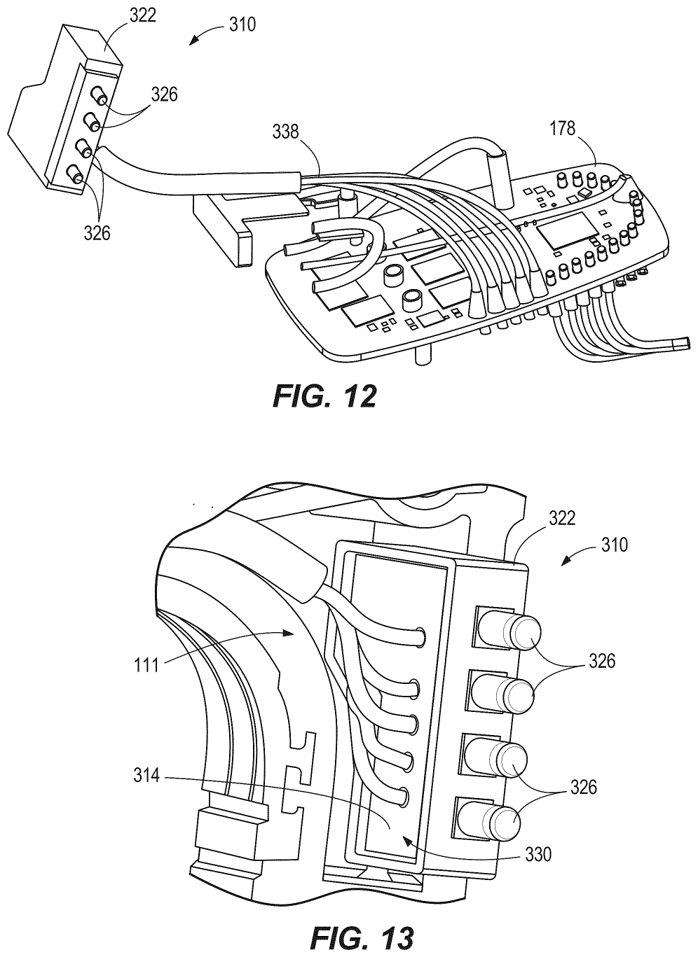

FIGS. 12-16 illustrate an exemplary light assembly 310 according to another embodiment of the disclosure. It should be appreciated that the light assembly 310 may be used as the first LED light assembly 300 (e.g., an LED fuel gauge) and/or the second LED light assembly 304. In other words, the die grinder 110 may include two separate light assemblies that have the same construction as the light assembly 310 described below.

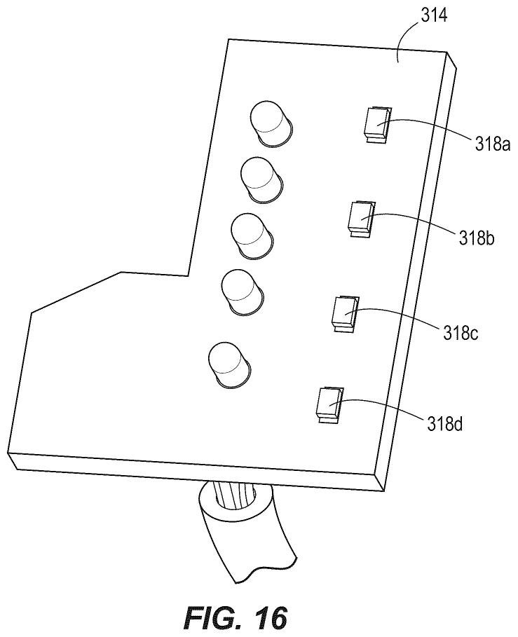

The light assembly 310 includes an auxiliary printed circuit board 314, a plurality of light-emitting diodes (LEDs) 318a, 318b, 318c, 318d (FIG. 16) mounted to the auxiliary printed circuit board 314, an auxiliary housing 322 in which the auxiliary printed circuit board (PCB) 314 is positioned, and a plurality of LED light pipes 326 extending from the housing 322. The housing 322 is a three-sided enclosure with a recess 330 defined therein. In the illustrated embodiment, the recess 330 is defined in the side of the housing 322 and is configured to receive the auxiliary PCB 314.

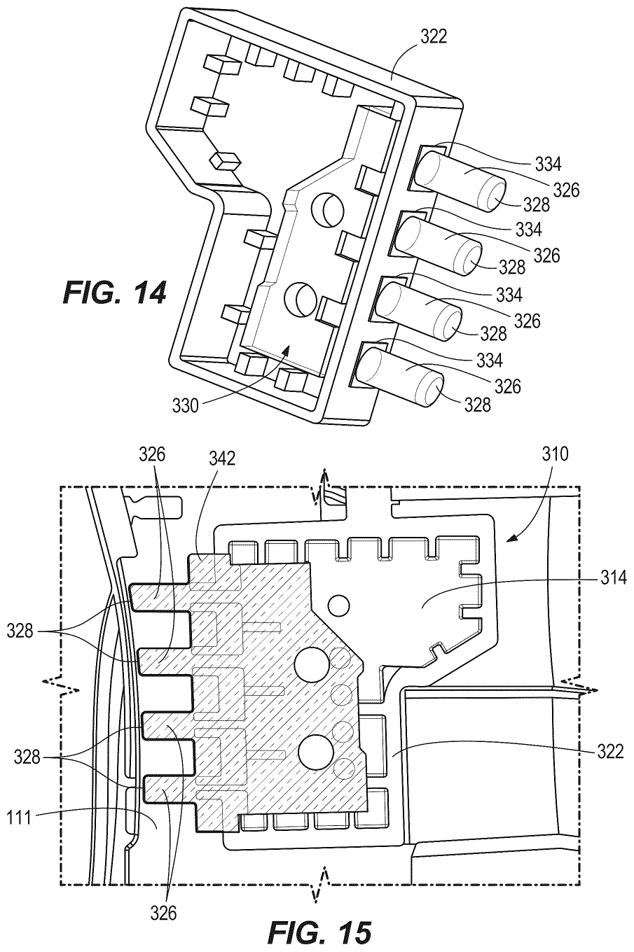

The housing 322 further includes a plurality of light apertures 334 (FIG. 14) formed in a side wall of the housing 322 adjacent a bottom wall of the housing 322. The light apertures 334 are sized to receive the LED light pipes 326, respectively. The light pipes 326 extend through the respective light apertures 334 and through the tool housing 111 (FIG. 15). Each light pipe 326 has a distal end 328 that is visible from an exterior of the tool housing 111. The light pipes 326 are positioned adjacent the LEDs 318a, 318b, 318c, 318d to transmit light emitted from the LEDs 318a, 318b, 318c, 318d to the exterior of the tool housing 111 through the light pipes 326. For example, the light is emitted from the distal ends 328 of the respective light pipes 326, which are visible from the exterior of the tool housing 111.

The housing 322 is filled with potting material to encapsulate the auxiliary PCB 314 and the LEDs 318a-d; therefore, dust and/or debris is prevented from covering the LEDs 318a-d. Therefore, the potting material prevents dust and/or debris ingress into the auxiliary housing 322. In some embodiments, the light pipes 326 may be internally reflective to block light leakage from the LEDs 318a, 318b, 318c, 318d through tool housing 111, such that all the light emitted from the LEDs 318a-d is transmitted from the exposed distal ends of the light pipes 326.

With reference to FIG. 15, in some embodiments of the die grinder 110, a vibration attenuating damper 342 is positioned between the tool housing 111 and the housing 322 of the light assembly 310. In the illustrated embodiment, the damper 342 is a compressible foam. In other embodiments, the damper 342 may be an elastomeric material such as rubber, polymers, or the like.

With reference to FIG. 12, the auxiliary PCB 314 is electrically connected to the first PCBA 178 via a plurality of electrical wires 338. The first PCBA 178 selectively provides power to the auxiliary PCB 314 to provide indication of the charge of the battery pack 156 and/or the operating mode of the die grinder 110. In some embodiments, the auxiliary PCB 314 may be activated when the battery pack 156 is initially attached to the die grinder 110, the trigger 160 is activated or the like.

In manufacturing the light assembly 310, the housing 322 is first made from a plastic molding process (e.g., injection molding) and then the LED light pipes 326 are co-molded with the housing 322. The auxiliary PCB 314 with the mounted LEDs 318a, 318b, 318c, 318d is inserted through the recess 330 in the housing and is secured to the housing 322. The electrical wires 338 are connected (e.g., by soldering, etc.) to the auxiliary PCB 314 and the first PCBA 178. Lastly, the housing 322 is filled with a potting material to encapsulate the auxiliary PCB 314 and the LEDs 318a-d and close the recess 330. Then, the completed light assembly 310 is inserted within the tool housing 111 with the light pipes 326 extending through corresponding apertures in the tool housing 111.

Although the invention has been described in detail with reference to certain preferred embodiments, variations and modifications exist within the scope and spirit of one or more independent aspects of the invention as described.

Various features of the invention are set forth in the following claims.

1. A power tool comprising:
a housing;
an electric motor disposed within the housing;
a first printed circuit board assembly configured to selectively supply electric current to the electric motor, causing the electric motor to activate and drive a tool element;
a battery receptacle configured to support a removable battery pack, the battery receptacle having a battery terminal block electrically connected to the battery pack to supply electrical current to the first printed circuit board assembly; and
a second printed circuit board assembly electrically connected between the first printed circuit board assembly and the battery terminal block, the second printed circuit board assembly having a fuse and a thermistor configured to detect a temperature of the fuse.

2. The power tool of claim 1, further comprising an electrical wire extending between the second printed circuit board assembly and the battery terminal block through which electrical current from the battery pack is transmitted to the first printed circuit board assembly, wherein heat from the battery terminal block is transferred to the second printed circuit board assembly via the electrical wire.

3. The power tool of claim 1, wherein the fuse is positioned inline between the first printed circuit board assembly and the battery terminal block.

4. The power tool of claim 1, wherein the second printed circuit board assembly is positioned in a series circuit between the battery terminal block and the first printed circuit board assembly.

5. The power tool of claim 1, wherein in response to a detected temperature of the fuse exceeding a predetermined high threshold value, the first printed circuit board assembly discontinues or reduce electrical current supplied to the electric motor.

6. The power tool of claim 5, wherein the first printed circuit board assembly restricts electrical current supplied to the electric motor until the thermistor detects that the temperature of the fuse is below a predetermined low threshold value.

7. The power tool of claim 1, further comprising a motor thermistor positioned proximate the electric motor to detect a temperature of the electric motor, wherein the first printed circuit board assembly is configured to discontinue or reduce electrical current supplied to the electric motor when the temperature of the electric motor exceeds a predetermined high threshold value.

8. A power tool comprising:
a tool housing;
an electric motor disposed within the tool housing;
a first printed circuit board assembly configured to selectively supply electric current to the electric motor, causing the electric motor to activate and drive a tool element;
a battery receptacle configured to support a removable battery pack, the battery receptacle having a battery terminal block electrically connected to the battery pack to supply electrical current to the first printed circuit board assembly; and
a light assembly supported within the tool housing and configured to indicate a state of charge of the battery pack, the light assembly including
an auxiliary housing,
an auxiliary printed circuit board supported within the auxiliary housing, the auxiliary printed circuit board having a plurality of light-emitting diodes (LEDs) mounted thereto, and
a plurality of light pipes extending through the tool housing and having respective distal ends that are visible from an exterior of the tool housing, wherein the light pipes are positioned adjacent the respective LEDs to transmit light emitted from the LEDs to the exterior of the tool housing.

9. The power tool of claim 8, further comprising a potting material encapsulating the auxiliary printed circuit board and the LEDs to prevent dust ingress into the auxiliary housing.

10. The power tool of claim 8, wherein the auxiliary housing is a three-sided enclosure with a recess defined therein, and wherein the auxiliary printed circuit board is received in the recess.

11. The power tool of claim 10, wherein the auxiliary housing includes a plurality of light apertures formed in a side wall thereof, and wherein the light pipes extend through the respective light apertures.

12. The power tool of claim 8, further comprising a vibration attenuating damper positioned between the tool housing and the auxiliary housing of the light assembly.

13. The power tool of claim 12, wherein the vibration attenuating damper is a compressible foam.

14. The power tool of claim 12, wherein the vibration attenuating damper is an elastomeric material.

15. The power tool of claim 8, wherein the light pipes are co-molded with the auxiliary housing.

16. A light emitting diode fuel gauge assembly configured to display a state of charge of a battery pack, the light emitting diode fuel gauge assembly comprising:
an auxiliary housing;
an auxiliary printed circuit board supported within the auxiliary housing, the auxiliary printed circuit board having a plurality of light-emitting diodes (LEDs) mounted thereto; and
a plurality of light pipes configured to extend through a tool housing and having respective distal ends that are configured to be visible from an exterior of the tool housing, wherein the light pipes are positioned adjacent the respective LEDs and are configured to transmit light emitted from the LEDs to the exterior of the tool housing.

17. The light emitting diode fuel gauge assembly of claim 16, further comprising a potting material encapsulating the auxiliary printed circuit board and the LEDs to prevent dust ingress into the auxiliary housing.

18. The light emitting diode fuel gauge assembly of claim 16, wherein the auxiliary housing is a three-sided enclosure with a recess defined therein, and wherein the auxiliary printed circuit board is received in the recess.

19. The light emitting diode fuel gauge assembly of claim 18, wherein the auxiliary housing includes a plurality of light apertures formed in a side wall thereof, and wherein the light pipes extend through the respective light apertures.

20. The light emitting diode fuel gauge assembly of claim 16, wherein the light pipes are co-molded with the auxiliary housing.
